(19) United States
(12) Patent Application Publication
(10) Pub. No.: US 2020/0296062 A1
(43) Pub. Date: Sep. 17, 2020

(54) System, Method, and Apparatus for Electronic Messaging

(71) Applicant: Len Wilson, Los Angeles, CA (US)

(72) Inventor: Len Wilson, Los Angeles, CA (US)

(21) Appl. No.: 16/299,017

(22) Filed: Mar. 11, 2019

(51) Int. Cl. H04L 12/58

(52) U.S. Cl. CPC H04L 51/10; H04L 51/066

(57) ABSTRACT

A system, method and apparatus enables a communication or messaging application to simultaneously display a potentially unlimited number of large-size and scale animated stickers or animated images in its Display Tray and in its Sent Display Window at framerates higher than 15 FPS without freezing or crashing the messaging application by drawing animated files from duplicate databases. By way of illustration and not limitation, the pixel (px) size of the stickers may, in some embodiments, be 100px×100px or higher and the frames per second (fps) of the stickers may be 15 fps or higher.

### CROSS-REFERENCE TO RELATED APPLICATIONS

Pursuant to 35 USC 119, this Application claims the right of priority to Provisional Patent Application Ser. No. 62/642,563 filed on Mar. 13, 2018. The content of said application is incorporated herein by reference in its entirety.

### GOVERNMENT CONTRACT

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to electronic messaging, and, more particularly, to a system, method, and apparatus that allows an electronic messaging program to simultaneously display and manipulate an increased number of animated files.

### BACKGROUND

A variety of electronic messaging systems are known in the art. Some of these enable the user to modify his or her message by inserting video, images, or designs into the text field or onto text itself. Some mobile applications enable the user to modify his or her message using “stickers.” Stickers, in the mobile application sense, refer to pre-made visual indications that a user may “stick onto” a text message or insert into a text messaging thread as a stand-alone visual sentiment.

Many such programs, however, are limited. For example, such messaging programs typically have limitations wherein the program can only support a certain number of animated files at a time based on their size and frame rate. For example, some programs may be able to support an above-average number of animated files, but only at low size and frame rate. Conversely, some programs can only support a few files of higher size and frame rate. When a program encounters a combination of the three parameters (number, size, frame rate) that is above its capacity, the program freezes and crashes (the “three-parameter problem”).

Some attempts at text message application solutions have been made. For example, U.S. Patent Application Publication No. 2016/0352667, incorporated by reference in its entirety herein, generally discloses a system and method for inserting nonverbal message elements into a text messaging thread. While this disclosure does address text messaging with nonverbal elements, it fails to overcome the three-parameter combination problem.

Another attempt, U.S. Patent Application Publication No. 2015/0381534, incorporated by reference in its entirety herein, generally discloses a system and method for turning a user's photos into selectable text messaging stickers. While this disclosure provides for enhanced text messaging visual content, it fails to disclose an adequate solution of how to simultaneously provide for an enhanced number of selectable animated files that also have a higher than average frame rate and are of higher than average size without causing the application to crash.

Yet another attempt, U.S. Patent Application Publication No. 2014/0225899, incorporated by reference in its entirety herein, generally discloses a system and method of analyzing a text and animating an image accordingly. While this disclosure offers an animating text message element, it fails to adequately provide for animating text message element solutions that solve the three-parameter problem.

An examination of the currently available animated sticker applications that exist on the market may perhaps be illustrative as well. For instance, Giphy® for Apple® iMessage®, well known in the art, contains many different animated stickers that can be selected, for example by tapping or dragging them, from its Display Tray and inserting them into an iMessage® chat discussion in the Sent Display Window. However, while Giphy® has a very large selection of animated stickers that run at framerates higher than the Apple® recommended 15 frames-per-second (fps), they are still very small in size and scale. While they appear larger in the Display List and Display Tray, a user can see how small they actually are in size and scale when a user taps or drags them, and they appear in the Sent Display Window. The reason for their small size and scale is due to the iMessage® platform's memory and technical constraints.

Another example, also well known in the art, is the Puffin Rock® application that allows users to select animated stickers from the Display Tray that are larger in size and scale as measured by pixels (px), and it runs them at frame rates higher than recommended by the appropriate hardware and software manufacturers, such as but not limited to the Apple®-recommended 15 fps in the Display Tray. However, while it does have stickers that run at a frame rate higher than the Apple® recommended 15 fps and the stickers appear to be larger than 160 px×160 px in the Sent Display Window, the Puffin Rock® stickers application has a limited total number of animated stickers that can appear as animating in its Display Tray. This is because 1) a large number of animated images such as more than nineteen 2) running at a higher frame rate than 15 fps, and that are also 3) larger than 160 px×160 px can make iMessage® freeze or crash due to the memory and technical constraints of iMessage®. As may be known to those of skill in the art, any software application and/or mobile device may suffer from the same limitations, in addition to the Apple® iMessage® application.

A user can currently see the limits of many messaging applications' limitations. For example, remaining with the iMessage® illustration, the iMessage® platform's memory and technical restraints when a user quickly scrolls up and down through a large number of animated stickers in either the Puffin Rock® or Giphy® Display Tray. To illustrate, when a user quickly scrolls up or down through a large number of animated stickers in the Giphy® or Puffin Rock® Display Trays, some of the animated stickers will begin to freeze their animations. When this happens, a user needs to scroll the Display List up and down multiple times in order for the frozen stickers to unfreeze, and in turn, allow a user to continue to see the stickers animate in the Display Tray again.

Thus, there remains a need for a system, method and apparatus that enables a text messaging application to simultaneously display a potentially unlimited number of large-size and scale animated stickers or animated images in its Display Tray and in its Sent Display Window at framerates higher than a messaging application's recommended specifications without freezing or crashing the messaging application.

### SUMMARY

The present disclosure is a directed system, method and apparatus that enables a text messaging application to simultaneously display a potentially unlimited number of large-size and scale animated stickers or animated images in its Display Tray and in its Sent Display Window at framerates higher than a messaging application's recommended specifications without freezing or crashing the messaging application. By way of illustration and not limitation, the pixel (px) size of the stickers may, in some embodiments, be 160 px×160 px or higher and the frames-per-second (fps) of the stickers may be 15 fps or higher.

It is contemplated that the present invention may operate on any text messaging application, such as but not limited to Apple® iMessage®, Android Messages®, Facebook Messenger®, Messenger Kids®, WhatsApp®, Viber®, Google Hangouts®, Google Allo®, Telegram®, WeChat®, Chomp SMS®, Handcent Next SMS®, Mood Messenger®, Pulse SMS®, Kik®, QKSMSR®, Signal Private Messenger®, Textra SMS®, Yaata SMS®, Send®, Line®, Slack®, Discord®, Snapchat®, Skype®, Voxer®, Blackberry Messenger®, Wickr Me®, Chatsecure®, Threema®, SilentPhone®, IM+®, Path Talk®, GroupMe®, Tango®, and so forth. Collectively, an analysis provided herein of iMessage® should be understood as applying to any messaging application unless otherwise specified. Unless otherwise indicated, “iMessage®” herein may refer to any of the above-named applications.

It is to be understood that the terms “sticker,” “animated sticker,” “gif,” “animated gif” “webp” file, or “animated image,” as described or depicted herein, in both their singular and plurals, is meant to encompass all forms of files that can display animation, imagery, image sequences, movement, or video. The terms “program” and “application” may also be used interchangeably herein as well.

Typically, electronic messaging sticker apps use the same animated image files for display in the Display List, the Display Tray, and the Sent Display Window. This single-set arrangement can cause the application to freeze and crash when the above-described parameters are met. In certain cases, it can create longer download and install times as well.

However, the present invention provides at least one innovative solution by creating a first set of animated image files that appear exclusively in the Display List and/or Display Tray (the Display Images), and a duplicate separate set of animated image files that appear exclusively in the Sent Display Window (the Sent Display Images). However, in some embodiments, the Sent Display Images may temporarily appear in the Display List and/or Display Tray. The present invention may provide for a Display Images Database and a Sent Display Images Database that store corresponding files for the Display Images and the Sent Display images, respectively. The Display Images Database and the Sent Display Images Database may be stored in whole or in part on any device or database system provided herein, such as but not limited to a mobile device, a desktop computer, a central server or database, a dispersed database, or any data storage element inherent to or known to accompany any element disclosed herein.

For example, in one embodiment, two sets of corresponding apng stickers (webp stickers, animated gifs, mp4s, or other animated image) may be provided: a first set that appears in the Display Tray and/or Display List (the “Display Images”) and a second set of images that appears in the Sent Display Window (the “Sent Display Images”). It is contemplated that duplicates of each sticker/animated image may be provided in each set. In some embodiments, however, the sticker/animated image may look or behave the same, and/or be of different size or frame rate. For example, in some embodiments one or more Display Images may be 200 px×200 px in size and scale and run at 30 fps. In some embodiments, the corresponding stickers in the Sent Display Images may be also be 200 px×200 px in size and scale and run at 30 fps, or they may be larger such as but not limited to 408 px×408 px in size and scale, or run at 30-60 fps. Any size, scale, and fps is contemplated for either or both of the Display Images and the Sent Display Images.

In some embodiments, both the Display Images and the Sent Display Images are contained, stored, or otherwise to be found within a central database location. In some embodiments, the Display Images and the Sent Display Images are contained, stored, or otherwise to be found within or across two or more separate databases. The shared database, the separate databases, or one or more of both may be entirely stored on a device such as a mobile phone or tablet, remotely stored such as via a cloud server, dispersed and stored across a number of computers, servers, or devices, or a combination of any database storage technique, system, or hardware known in the art. In some embodiments, the Display Images may be sourced from a Display Images database. In some embodiments, the Sent Display Images may be sourced from a Sent Display Images database. In some embodiments, both the Display Images and Sent Display Images may be sourced from a Combined File Database.

To practice an aspect of the invention, in some embodiments, the present invention may first provide that the Display Images, which in some embodiments may be 200 px×200 px in size and scale run at 30 fps, may appear in the Display Tray and/or Display List. At this stage, the Sent Display Images may be hidden. Next, a user may select a Display Image by interacting with the Display Tray. This includes, but is not limited to touching, tapping, pressing, hovering over, or dragging something in the Display Tray. Immediately, the present invention may provide that a corresponding Sent Display Image may appear in the Sent Display Window, and in some embodiments the Sent Display Image may be a larger or higher frame rate version of the Display Image, such as a Sent Display Image that is 408 px×408 px and runs at 30-60 fps.

This method of having a first, separate set of files that only appear in the Display List and/or Display Tray and a second, also unique set of corresponding files that only appear in the Sent Display Window allows a messaging application to simultaneously contain and display a potentially infinite number of animated images in the Display List and/or Display Tray while also displaying animated images in the Sent Display Window that are large in size and scale (such as but not limited to, for example 160 px×160 px or larger) and animate at higher frame rates higher than recommended 15 fps. It should be noted that images in the Sent Display window could also be smaller in size and scale relative to images in the Display Tray without departing from the invention.

This method can be mixed and matched with any type of file that displays animation that a developer sees fit. It only matters that the animated images that appear in the Display List and Display Tray are a separate and unique set of files that are different from the animated image files that appear and display in the Sent Display Window.

For example, in an embodiment, the Display Images may exclusively display mp4 or webp files that are smaller in size and scale, while the Sent Display Images are comprised of a different, but corresponding set of webp or gif files that are larger in size and scale. Or, in an embodiment, the Display Images may exclusively display gif files that are smaller in size and scale, while the Sent Display Image comprise a different, but corresponding set of gif files that are larger in size and scale. In yet another embodiment, the Display Images may exclusively display webp files that are smaller in size and scale, while the Sent Display Image comprise a different, but corresponding set of apng files that are larger in size and scale. Conversely, another embodiment, the Display Images may exclusively display webp files that are smaller in size and scale, while the Sent Display Image comprise a different, but corresponding set of mp4 files that are larger in size and scale. An illustrative and non-limiting expression, illustration, or example of this can be found at: https://itunes.Apple.com/us/app/big-heads/id1286472244?mt=8

As may be perceived by those of skill in the art, in some embodiments, the Sent Display Images may be displayed in the Display Tray and/or Sent Display Window. By way of non-limiting example, in some embodiments, when a user touches a Display Image in the Display Tray, a second and corresponding animated file, the file sourced from the Sent Display Images and/or its corresponding database, may “hover” over the selected Display Image. In some embodiments, a user may then drag the Sent Display Image from the Display Tray to the Sent Display Window, if the user chooses to use that particular file.

While the above illustrations generally describe apng, webp, mp4, and gif file types, it is contemplated that any compatible file type that plays audio, displays animation, video, or movement may be similarly employed by the present invention.

The present invention can also work by mixing other technologies, such as Unity® into the Display List and/or Display Tray. For example, the Display List and/or Display Tray could be an interface created in Unity® that shows Display Images, but the Sent Display Images that appear in the Sent Display Window may still comprise a separate individual apng, gif file, webp, or animated image file. The types of code, animated image files, and ways a user can utilize the present invention to mix and match various elements is infinite. The central advancement provided by the present invention is the capacity for and/or configuration wherein a first standalone set of animated imagery only appears in the Display Tray and a second standalone set of corresponding unique animated images appears in the Sent Display Window.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for electronic messaging is implemented.

FIG. 2 illustrates an exemplary embodiment of a mobile device shown in FIG. 1.

FIG. 3 illustrates an exemplary embodiment of the system for electronic messaging as implemented by a mobile device.

FIG. 4 illustrates an exemplary method for electronic messaging according to an embodiment of the present invention.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

In some embodiments, one or more elements, data storage systems, operating systems, or other elements may be stored and/or run on a blockchain or blockchain-like system wherein a series of immutable records are linked in the blockchain method and stored across a variety of communicating nodes that act as a decentralized distributed computing system and/or distributed ledger.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

It is to be understood that the terms “sticker,” “animated sticker,” “gif” file, “animated gif” file, “apng” file, “webp” file, “video”, “mp4” or “animated image,” as described or depicted herein, is meant to encompass all forms of files that can display animation, imagery, image sequences, movement, or video in both singular and plural forms. Unless specified otherwise, any of “sticker,” “animated sticker,” “gif” file, “animated gif” file, “apng” file, “video”, “mp4” “webp” file, or “animated image,” may be substituted for each other. Moreover, “corresponding” as used herein indicates that the two or more files in question are either identical or substantially similar to each other. It is contemplated that, in some embodiments, duplicates of animated files may exist in two or more databases accessible by the present invention. In such a case, each of the pair may be said to “correspond” to the other.

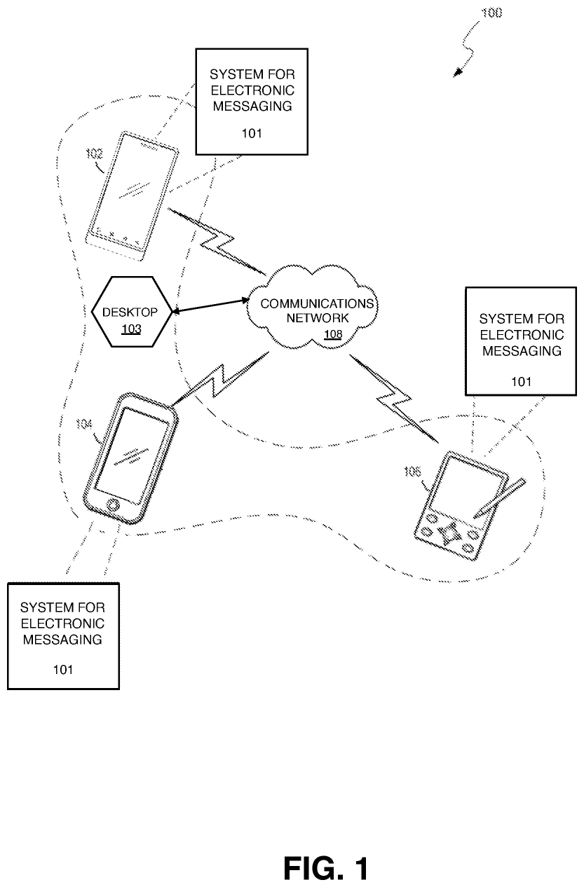

FIG. 1 illustrates an exemplary embodiment of a system, method and apparatus for electronic messaging 100 that includes a plurality of electronic devices communicatively coupled to one another. By way of example, and not limitation, FIG. 1 illustrates mobile devices 102, 104, and 106, and desktop computer 103 that incorporate a system for electronic messaging 101 and are communicatively coupled via a communications network 108. Each of the mobile devices 102, 104, and 106 may be embodied as a mobile computing device such as, for example and without limitation, a smartphone or tablet computer that incorporates cellular telephone functionality. Notably, the communications network 108 can use one or more of various communications types such as, for example and without limitation, short range device-to-device wireless data transfer (i.e Bluetooth), cellular, and Wi-Fi communications. In some embodiments, one or more nodes (not pictured) may take the place of one or more of mobile devices 102, 104, and 106, and desktop computer 103.

Users of desktop computer 103 and mobile devices 102, 104, and 106 may be users of at least one communications network 108 known to those skilled in the art. For instance, as noted above, communications network 108 may comprise a peer-to-peer network, a cloud-based computing network, a fog computing network, a blockchain computing network, or any other communications network 108 known in the art capable of secure or unsecure data transfer. In some embodiments, communications network 108 may be facilitated by a website that may require a registration and login prior to use. Moreover, in at least one embodiment, one or more of desktop computer 103 and mobile devices 102, 104, and 106 may be configured to communicate directly with one another via short range device-to-device wireless data transfer (i.e Bluetooth).

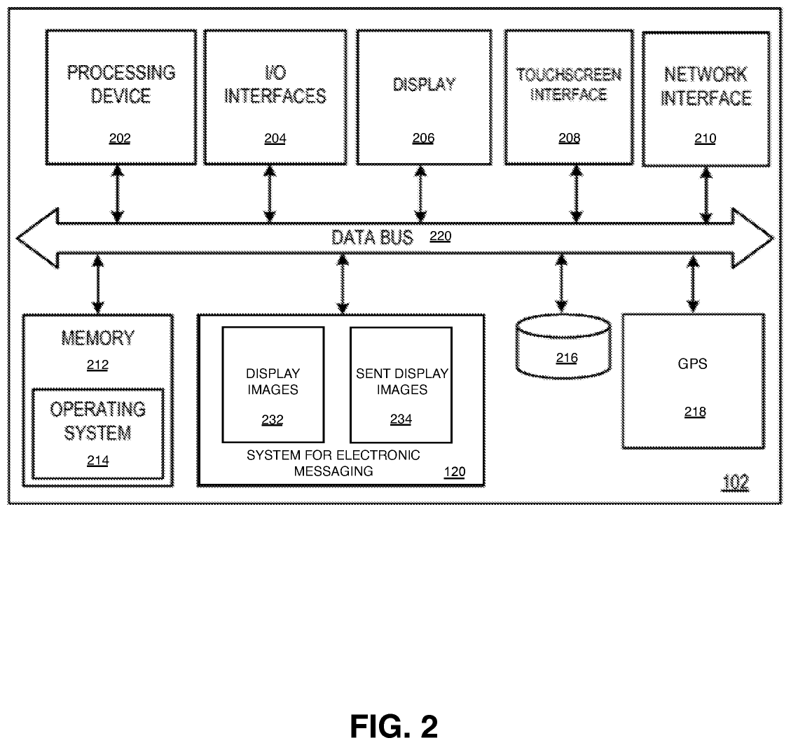

FIG. 2 illustrates at least one mobile device 102, wherein each mobile device 102 may, in some embodiments, comprise a networked computer device in communication with communications network 108 or with another mobile device 102 via short-range device-to-device data transfer. In some embodiments, any of mobile devices 102, 104, and 106, and desktop computer 103 may, in addition to their roles as either a first electronic device or a second electronic device, may alternatively or simultaneously comprise at least one mobile device 102.

In the embodiment depicted in FIG. 2, mobile device 102 may comprise, at least, at least one processing device (processor) 202, at least one input/output interface 204, at least one display 206, at least one user interface 208, at least one network interface 210, at least one memory 212, at least one operating system 214, at least one mass storage 216 and at least one GPS 218, with each communicating across a local data bus 220. Additionally, at least one mobile device 102 may store at least one display image 232 and at least one sent display image 234. In some embodiments, mobile device 102 may communicate with other mobile device(s) 102 via one or more communications networks (not shown in FIG. 2).

The processing device 202 may include any custom made or commercially available processor, a central processing unit (CPU) or an auxiliary processor among several processors associated with mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 212 can include any one of a combination of volatile memory elements (e.g., random-access memory (RAM, such as DRAM, and SRAM, etc.)) and nonvolatile memory elements. The memory typically comprises native operating system 214, one or more native applications, emulation systems, or emulated applications for any of a variety of operating systems and/or emulated hardware platforms, emulated operating systems, etc. For example, the applications may include application specific software which may comprise some or all the components of mobile device 102. In accordance with such embodiments, the components are stored in memory and executed by the processing device. Note that although depicted separately in FIG. 2, the system for electronic messaging 101 may be resident in memory such as memory 212. As mentioned above, in some embodiments, one or more mobile devices 102 may not have their own memory 212 and/or operating system 214 or may store incomplete memory 212 and/or operating system 214, and may therefore draw upon other mobile devices 102 for use of one or more memory units 212 and/or operating system elements 214 via a mobile to mobile communication system or another communications medium, as discussed herein.

Touchscreen interface 208 may be a user interface of any type, including one that does not support touchscreen input, configured to detect contact within the display area of the display 206 and may provide such functionality as on-screen buttons, menus, keyboards, etc. that allows users to navigate user interfaces by touch. User interface 208 may also be a keyboard, a mouse, a microphone, a vision tracking system, a motion-capture system, a trackball, or any other known interface with a computing system. For some embodiments, mobile device 102 may also comprise GPS 218 or other means to determine the location of the mobile device 102.

One of ordinary skill in the art will appreciate that the operating system 214 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 2, network interface device 210 comprises various components used to transmit and/or receive data over a networked environment such as depicted in FIG. 1. When such components are embodied as an application, the one or more components may be stored on a non-transitory computer-readable medium and executed by the processing device.

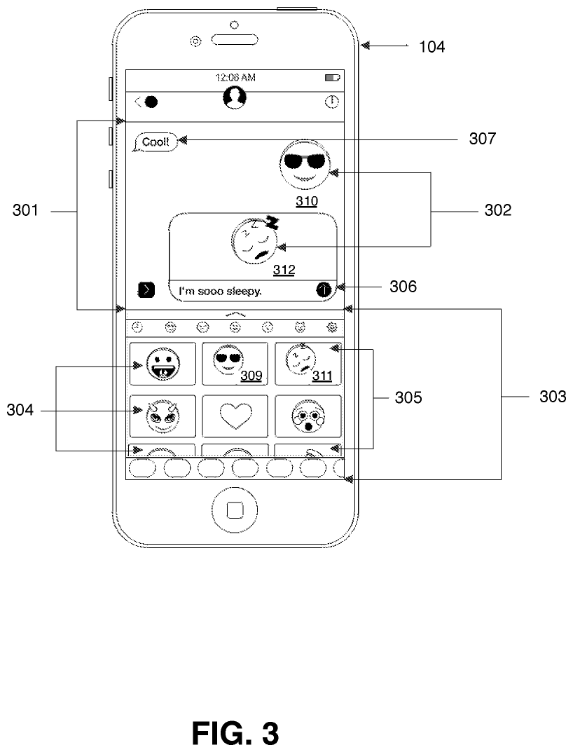

FIG. 3 illustrates an exemplary embodiment of a mobile device 104 running a system and method for electronic messaging. In FIG. 3, a viewer may perceive Sent Display Window 301, Sent Display Images 302, Display Tray 303, Display Images 304, Display List 305, Message Input Box 306, Sent Text(s) 307, Display Image Cool Face 309, Sent Display Image Cool Face 310, Display Image Sleepy Face 311, and Sent Display Image Sleepy Face 312.

In some embodiments, the locations or configurations of Sent Display Window 301, Display Tray 303, Display List 305, Display Images 304, and Sent Display Images 302 may vary, such as but not limited to when the present invention is run on a different messaging application, on a different phone, or on a tablet, desktop computer, or other compatible device, or on another such device using a different messaging application. Relatedly, FIG. 3 illustrates one or more unique animated image files in Sent Display Window 301, Display Tray 303, Display List 305, Display Images 304, and Sent Display Images 302.

As may be understood by those of skill in the art, the animated image files provided in FIG. 3 are solely for illustration purposes and may be of any compatible file in one or more embodiments. For example, while FIG. 3 only points to three specific Display Images 304 and only shows a total of nine Display Images 304 in Display List 305, it is to be understood that a possibly infinite number of Display Images 304 can appear in Display List 305, and that they can be revealed by interacting with Display Images 304, Display List 305, or other graphical elements in Display Tray 303. In some embodiments, interacting with Display Images 304, Display List 305 and other graphical elements in Display Tray 303 may comprise pressing, touching, sliding, dragging, or talking. Of course, other methods of interacting with the cited elements are also contemplated, the foregoing are offered by way of example only and not limitation.

It is also meant to be understood in FIG. 3 that the total number of Display Images 304 make up a Display List 305, and that both Display Images 304 and Display Lists 305 may appear in (or “live” in) the space of the Display Tray 303.

It should also be understood in FIG. 3 that while a Sent Display Image 302 typically lives in the Sent Display Window 301, in some embodiments a Sent Display Image 302 may temporarily appear in the Display Tray 303 when a user is interacting (pressing, touching, tapping, hovering, sliding, dragging, or talking) with Display Images 304 or Display List 305 in Display Tray 303. This is because interacting with elements in Display Tray 303 causes Sent Display Images 302 to appear. For example, if a user were to press and hold a Display Image 304, a Sent Display Image 302 may appear above it and allow a user to drag the Sent Display Image 302 into the Sent Display Window 301.

FIG. 3 also illustrates at least one aspect of the present invention's functionality via Display Image Cool Face 309, Sent Display Image Cool Face 310, Display Image Sleepy Face 311, and Sent Display Image Sleepy Face 312. In FIG. 3, a viewer may perceive that Display Image Cool Face 309 and Sent Display Image Cool Face 310 are illustrated as identical or substantially the same animated files, and that Display Image Sleepy Face 311 and Sent Display Image Sleepy Face 312 are illustrated as identical or substantially the same animated files. In some embodiments, Display Image Cool Face 309 and Sent Display Image Cool Face 310 may be duplicates or near-duplicates stored in identical or near-identical form in the Display Images Database and the Sent Display Images Database, respectively (neither pictured).

Thusly, in some embodiments such as generally shown in FIG. 3, a Display Image 304 such as Display Image Cool Face 309 that is sourced from the Display Images Database is provided in Display Tray 303. Once a user selects the Display Image 304, in this example Display Image Cool Face 309, the present invention draws the corresponding Sent Display Image 302, here Sent Display Image Cool Face 312, sourced from the Sent Display Images Database, and displays it in Send Display Window 301. In this way, the present invention draws a first version of the animated file from a first database to use in Display Tray 303, while drawing a corresponding and identical or near identical version of the first animated file for use in the Sent Display Window 301. In some embodiments, by using this dual-database and dual-version animated file system, the present invention minimizes the strain put on the computing device on which the present invention runs, by splitting the processing demands into two tasks.

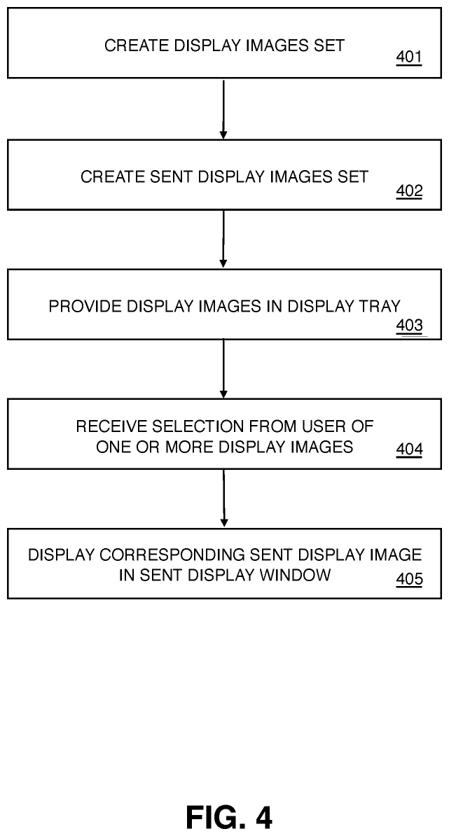

FIG. 4 generally illustrates an exemplary method for electronic messaging wherein the method comprises creating at least one Display Images Set 401, creating at least one corresponding Sent Display Images Set 402, providing one or more Display Images in at least one Display Tray 403, receiving a selection of a Display Image by a user 404, and displaying at least one corresponding Sent Display Image in at least one Sent Display Window 405.

Display Images Set 401 may be stored in at least one Display Images Database (not pictured), while Sent Display Images Set 402 may be stored in at least one Sent Display Images Database (not pictured). As discussed above, when a user selects one or more Display Images 404, the present invention may draw the corresponding Sent Display Image (not pictured) and display the corresponding Sent Display Image in the at least one Sent Display Window 405.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### Conclusions, Ramifications, and Scope

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed present invention. The above description of embodiments of the present invention is not intended to be exhaustive or limited to the precise form disclosed above or to a particular field of usage.

While specific embodiments of, and examples for, the present invention are described above for illustrative purposes, various equivalent modifications are possible for which those skilled in the relevant art will recognize.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

What is claimed is:

1. A system for electronic communication or messaging, comprising:
an electronic device configured to run a communication or messaging application, wherein within the communication or messaging application, the electronic device is operative to:
provide at least one display images database containing at least one first display image, wherein the at least one first display image is an animated image, and wherein the at least one first display image has at least one first display image size and at least one first display image frame rate;
provide at least one sent display images database containing at least one sent display image, wherein the at least one sent display image is an animated image, wherein the at least one display image has at least one sent display image display size and at least one sent display image frame rate, and wherein at least one sent display image corresponds to at least one first display image;
provide at least one display list comprising at least one first display image;
provide the display list in a display tray within the communication or messaging application;
provide a sent display window within the communication or messaging application;
receive a selection by a user, wherein the selection comprises at least one first display image;
identify at least one corresponding sent display image that corresponds to the selection; and
display the at least one corresponding sent display image in a sent display window.

2. The system of claim 1, wherein the at least one first display image size is larger than 150 pixels×150 pixels and the at least one first display image has a frame rate that is higher than 15 frames per second.

3. The system of claim 1, wherein the at least one sent display image size is larger than 150 pixels×150 pixels and the at least one sent display image has a frame rate is higher than 15 frames per second.

4. The system of claim 1, wherein at least one first display image is an apng, gif, webp, any type of image sequence, or any type of video file.

5. The system of claim 1, wherein the at least one first display image is a file selected from a group consisting of an apng, gif, webp, any type of image sequence, or any type of video file.

6. The system of claim 1, wherein at least one sent display image is an apng, gif, webp, any type of image sequence, or any type of video file.

7. The system of claim 1, wherein the at least one sent display image is a file selected from a group consisting of an apng, gif, webp, any type of image sequence, or any type of video file.

8. An apparatus comprising at least a non-transitory, tangible computer-readable medium having stored thereon computer-executable instructions, which, when executed by a computer processor, enable performance of the method comprising:
providing, by a first electronic device, at least one display images set comprising at least one first animated image, wherein the at least one first animated image has at least one first animated image display size and at least one first animated image frame rate;
providing, by the first electronic device, a sent display images set comprising at least one second animated image, wherein the at least one second animated image has at least one second animated image display size and at least one second animated image frame rate, and wherein the at least one second animated image corresponds to the at least one first animated image;
compiling, by the first electronic device, a display list comprised of at least one first animated image;
providing, by the first electronic device, the display list in a display tray within the messaging application;
receiving, by the first electronic device, a selection by a user, wherein the selection comprises at least one first animated image; and
displaying, by the first electronic device, the corresponding at least one second image in a sent display window.

9. The apparatus of claim 8, wherein the at least one first animated image display size is larger than 160 pixels×160 pixels and the first animated image frame rate is higher than 15 frames per second.

10. The apparatus of claim 10, wherein the at least one second animated image display size is larger than 160 pixels×160 pixels and the first animated image frame rate is higher than 15 frames per second.

13. The apparatus of claim 8, wherein the at least one first animated image is an apng, gif, webp, any type of image sequence, or any type of video file.

12. The apparatus of claim 8, wherein the at least one second animated image is an apng, gif, webp, any type of image sequence, or any type of video file.

13. A method of electronic communication, comprising:
providing, by a first electronic device, at least one display images database containing at least one first display image, wherein the at least one first display image is an animated image, and wherein the at least one first display image has at least one first display image size and at least one first display image frame rate;
providing, by the first electronic device, at least one sent display images database containing at least one sent display image, wherein the at least one sent display image is an animated image, wherein the at least one display image has at least one sent display image display size and at least one sent display image frame rate, and wherein at least one sent display image corresponds to at least one first display image;
providing, by the first electronic device, at least one display list comprising at least one first display image;
providing, by the first electronic device, the display list in a display tray within the communication or messaging application;
providing, by the first electronic device, a sent display window within the communication or messaging application;
receiving, by the first electronic device, a selection by a user, wherein the selection comprises at least one first display image;
identifying, by the first electronic device, at least one corresponding sent display image that corresponds to the selection; and
displaying, by the first electronic device, the at least one corresponding sent display image in a sent display window.

14. The method of claim 19, wherein the at least one first display image size is larger than 150 pixels×150 pixels and the at least one first display image frame rate is higher than 15 frames per second.

15. The method of claim 17, wherein the at least one sent display image size is larger than 150 pixels×150 pixels and the at least one sent display image frame rate is higher than 15 frames per second.

16. The method of claim 17, wherein the at least one first display image is an apng, gif, webp, any type of image sequence, or any type of audio or video file; and at least one sent display image is an apng, gif, webp, any type of image sequence, or any type of audio or video file.
